(19) United States
(12) Patent Application Publication
(10) Pub. No.: US 2010/0187381 A1
(43) Pub. Date: Jul. 29, 2010

(54) Rolling Device with Adjusting Device

(76) Inventors: Otmar Giesler, Kreuztal (DE); Herbert Sonneborn, Bad Laasphe (DE)

Correspondence Address: ABELMAN, FRAYNE & SCHWAB, 666 THIRD AVENUE, 10TH FLOOR, NEW YORK, NY, 10017, US

(21) Appl. No.: 12/733,157

(22) PCT Filed: Aug. 5, 2008
(86) PCT No.: PCT/EP2008/006430

§ 371 Date: Mar. 11, 2010

(30) Foreign Application Priority Data
Aug. 7, 2007 (DE) 10 2007 037 303.3
Dec. 6, 2007 (DE) 10 2007 058 729.7

(51) Int. Cl. F16M 11/22

(52) U.S. Cl. 248/188.8

(57) ABSTRACT

The invention relates to a rolling apparatus (1) with rolling stand pillars (9), wherein at least one roll (2) of the rolling stand is located in the spatial region (15) between the stand pillars (9), and wherein at least one adjusting device (6) is provided for adjusting the roll (2), wherein at least one adjusting device (6) is located on the side of the stand pillar (9) facing away from the roll (2).

### TECHNICAL FIELD

The invention relates to a rolling apparatus with an adjustment device, in particular for adjusting a horizontal offset of a roll of a rolling apparatus, in particular, according to the preamble of claim 1.

### STATE OF THE ART

Rolling apparatuses or rolling stands are known in the state of the art since long ago. In particular, known are rolling stands in which a working roll is horizontally offset relative to an adjacent backup roll to provide for a horizontal stabilization. This is particularly important when the rolling apparatus should execute different pass programs. As adjustment devices, reciprocating spindle elements, adjusting cylinders, and wedge adjusting means are known. Adjustment devices with wedges are disclosed, e.g., in DE 17 770 54 A1. Adjustment cylinders are disclosed, e.g., in DE 15 27 713 A.

The known adjustment devices are relatively expensive and require an increased constructional space. Further, they are provided in stand windows necessary for a roll exchange. Because a roll exchange is carried out in the rolling apparatuses, the adjustment devices present an obstacle during the roll exchange which requires an expensive roll exchange carriage which prolongs the replacement of the work rolls. Thereby, the idle time of a rolling installation is noticeably increased, which reduces the economic efficiency of the rolling installation.

### DESCRIPTION OF THE INVENTION, OBJECT, SOLUTION, ADVANTAGES

It is an object of the present invention to provide a rolling apparatus such as, in particular, a rolling stand with which the drawbacks of the state of the art are reduced when they cannot be completely prevented.

According to the invention, this object is achieved with a rolling apparatus having a rolling stand with stand pillars, with at least one roll of the rolling stand being located in a spatial region between the stand pillars, and at least one adjusting device for adjusting the roll, with the at least one adjusting device being located on a side of a stand pillar remote from the roll. Thereby, it is achieved that a constructional space necessary for the roll exchange remains substantially free.

It is advantageous, when an adjustment device is provided on each of the pillars on a side of the pillar remote from the roll.

It is useful, when the at least one adjustment device is connected with an outer ring of a roll bearing by arms. The arms engage around the stand pillars or extend on both sides of the same.

It is advantageous when the at least one adjusting device has a wedge that can be displaced between two elements in order to displace the arms of the adjusting device in direction toward the roll or in direction away from the roll so that the roll is displaceable in a direction transverse to the roll axis.

It is also useful when the adjusting device has an actuator which is a hydraulic or electrical actuator. With the actuator, the positioning of the wedge between the elements and, thus, the adjustment of the apparatus is controlled.

It is further advantageous when the adjustment device, together with the actuator, is provided on a side of the pillar remote from the roll.

It is particularly advantageous when the apparatus comprises at least four adjusting devices located on a respective side of a stand pillar.

Advantageous further modifications are described in sub-claims.

### SHORT DESCRIPTION OF THE DRAWINGS

Below, the invention will be explained in detail on the basis of the exemplary embodiment with reference to the drawings.

The drawings show:

FIG. 1 a schematic view of a working roll with adjustment;

FIG. 2 a cross-sectional view along line B-B in FIG. 1;

FIG. 3 a cross-sectional view along line C-C in FIG. 2;

FIG. 4 a side view of the arrangement according to FIG. 1; and

FIG. 5 a cross-sectional view along line A-A in FIG. 1.

### PREFERRED DESIGN OF THE INVENTION

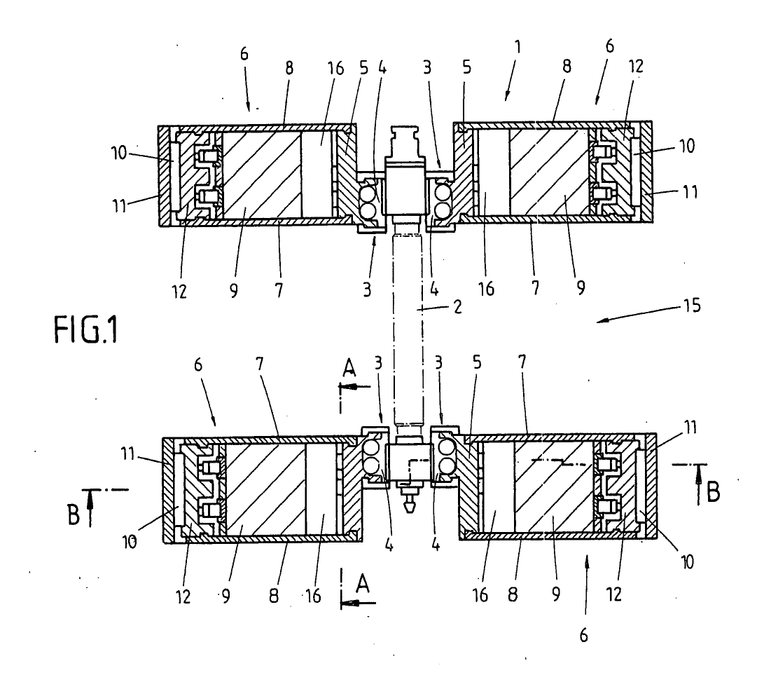

FIG. 1 shows schematically a view of a rolling apparatus 1 with a stand, such as a rolling stand, with a working or intermediate roll 2 receivable in a bending device 3, 4, 5.

The bending device 3, 4, 5 is formed of a cylinder block 5 and bending bridges 3 with guide rods 4 and which receives the roll and is connected with an adjustment device 6. The roll 15 is preferably arranged in a spatial region between stand pillars 9 of the rolling stand.

The adjustment device 6 serves for a horizontal adjustment of the roll 2 in a direction transverse to the axis of the roll 2. The adjustment device 6 has two arms 7, 8 that sidewise engage the stand pillar 9 to connect the adjustment device 6 with the bending device 5. The adjustment device 6 and the bending device 5 are located on different sides of the pillars 9.

As shown, two adjustment devices 6 are provided on both sides of an end of the roll 2, so that both adjustment devices 6 displace the bending device 5 to one side by a corresponding wedge displacement. As a result, the arms 6, 7 and the bending device 5 are withdrawn at one side are pulled in at the opposite side. At that, the wedge 10 is pushed between two elements 11, 12 so that the element 12 is displaced from the element 11, whereby the element 12 displaces the arms 7,8 and, thereby, the bending device 5 leftwardly in FIG. 1.

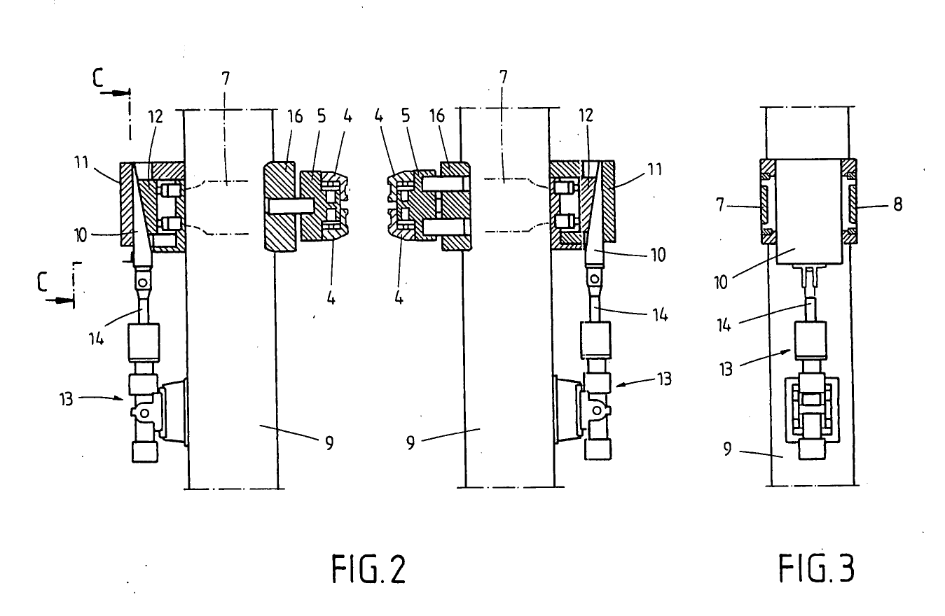

FIG. 2 shows a cross-sectional view of the adjustment device 6 along line B-B. It shows adjustment actuators 13 that can push the wedge 10 between the element 11 and the element 12 or withdraw it, so that the arms 7, 8, which are connected with the element 12, can be displaced in a direction toward the roll 2 or away from the roll 2. An adjustment actuator can be a hydraulic actuator, as an adjustment cylinder, or an electrical actuator such as an electric motor. It can be clearly seen, that the adjustment actuator, together with the wedge 10 and the elements 11, 12 against which the wedge 10 is supported, are arranged on a side of the stand pillar 9 of the rolling apparatus remote from the roll 2.

FIG. 3 shows a cross-sectional view of the device in FIG. 2 along line C-C. It can be seen that the wedge 10 is pivotally supported on a lever arm 14 of the actuator 13, so that at least small tilting moments that may act on the wedge, can be absorbed.

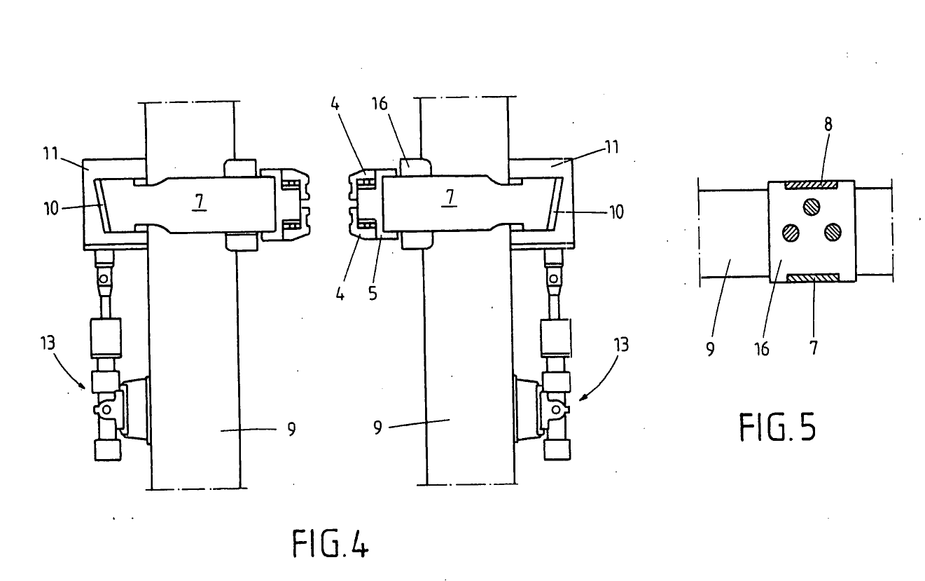

FIG. 4 shows a side view of the apparatus of FIG. 1. The drawing clearly shows the arms 7 which are connected with the element 12 in order to provide for displacement of the element 12 by pushing the wedge between the elements 11 and 12.

FIG. 5 shows a cross-sectional view of the apparatus of FIG. 1 along line A-A, with FIG. 5 showing a connection of the arms 7, 8 with the bending device 5. To this end, a solid block 16 is provided with recesses in which the arms 7, 8 engage and in which the arms 7, 8 are guided.

### LIST OF REFERENCE NUMERALS

1 Rolling apparatus
2 Working roll
3 Roll support
4 Bearing ring
5 Bending device
6 Adjustment device
7 Arm
8 Arm
9 Stand pillars
10 Wedge
11 Element
12 Element
13 Actuator
14 Lever arm, arm
15 Spatial region

1-7. (canceled)

8. A rolling apparatus (1), comprising a rolling stand having stand pillars (9), wherein at least one roll (2) of the rolling stand is located in a spatial region (15) between the stand pillars (9); and at least one adjusting device (6) for adjusting the roll (2), wherein the at least one adjusting device (6) is located on a side of a stand pillar (9) remote from the roll,
characterized in that
an adjustment device (6) is provided on each of the pillars (9) on a side of the pillar (9) remote from the roll (2).

9. A rolling apparatus (1), comprising a rolling stand having stand pillars (9), wherein at least one roll (2) of the rolling stand is located in a spatial region (15) between the stand pillars (9); and at least one adjusting device (6) for adjusting the roll (2), wherein the at least one adjusting device (6) is located on a side of a stand pillar (9) remote from the roll,
characterized in that
the at least one adjusting device (6) has a wedge (10) that can be displaced between two elements (11, 12) in order to displace the arms (7, 8) of the adjusting device in a direction toward the roll (2) or in direction away from the roll (2), so that the roll (2) is displaceable in a direction transverse to the roll axis.

10. A rolling apparatus, comprising a rolling stand having stand pillars (9), wherein at least one roll (2) of the rolling stand is located in a spatial region (15) between the stand pillars (9); and at least one adjusting device (6) for adjusting the roll (2), wherein the at least one adjusting device (6) is located on a side of a stand pillar (9) remote from the roll,
characterized in that
the apparatus comprises at least four adjusting devices (6) located on a respective remote side of a stand pillar (9).

11. A rolling apparatus according to claim 8,
characterized in that
the at least one adjustment device (6) is connected with a bending device (5) of the roll by arms (7, 8).
the at least one adjustment device (6) is connected with a bending device (5) of the roll by arms (7, 8).

12. A rolling apparatus according to claim 8,
characterized in that
the adjusting device (6) has an actuator (13) which is a hydraulic or electrical actuator.
